(19) United States
(12) Patent Application Publication
(10) Pub. No.: US 2007/0141720 A1
(43) Pub. Date: Jun. 21, 2007

(54) Automated analysis of cations in acidic solutions

(76) Inventors: Larry N. Stewart, San Jose, CA (US); Jimmy K. Dzuong, San Jose, CA (US); Harmesh K. Saini, Santa Clara, CA (US); Quoc Truong, San Leandro, CA (US); Hien Nguyen, San Jose, CA (US); Michael Ahern, Mountain View, CA (US); Bijan Ghaderi, San Mateo, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/305,624

(22) Filed: Dec. 16, 2005

(51) Int. Cl. G01N 1/18

(52) U.S. Cl. 436/178

(57) ABSTRACT

In one embodiment, a matrix elimination apparatus for eliminating an acidic matrix includes: at least one column packed with a weak anion exchange resin; a source of samples, each sample having an acidic matrix; a basic solution source; a weakly acidic metal complexing reagent source, and an at least one pump, wherein the matrix elimination apparatus is configured such that the at least one pump can sequence through the acts of: a) pumping the basic solution through the column to regenerate the column, b) pumping the weakly acid metal complexing reagent through the column to activate the column; and c) pumping one of the samples through the activated column to provide a processed sample whose acidic matrix is eliminated.

### BACKGROUND OF THE INVENTION

The present invention relates to automated metrology, and more particularly to the automated analysis of cations in acidic solutions.

The analysis of trace amounts of cations such as metal cations is often hindered by the presence of an acidic matrix. For example, semiconductor manufacturers must be on guard against chemical contamination in their various processing baths. Metal contaminants, even in trace concentrations such as the parts per trillion (ppt) range may cause manufacturing flaws. To address this need in the art, automated in-process mass spectrometry (IPMS) systems have been developed such as that disclosed in commonly-assigned U.S. application Ser. No. 10/086,025, the contents of which are incorporated by reference herein. However, there are a number of semiconductor process bath solutions such as semiconductor cleaning solution 2 (SC2) that are harshly acidic. Due to the high matrix of protons and chloride ions in SC2, the simultaneous online determination of trace levels of many metals is very difficult. Such a matrix obscures the ionization of metals in the mass spectrometer. Because the metals are not ionized, the mass spectrometer cannot measure them. Thus, the analysis of metals in such matrices often involves the dilution of the matrix to reduce the matrix effect. But dilution of ultra trace concentrations of metal ions tends to dilute the metal ion concentration to immeasurable levels. The background noise overwhelms such diluted ultra trace concentrations such that the mass spectrometer cannot accurately characterize them. As an alternative, the matrix may be eliminated by heat and/or evaporation. But volatile species are then lost. Moreover, it usually requires 24 to 48 hours to complete the analysis in such instances. Accordingly, in most cases, if a problem is detected, such as impurities in the SC2, processing of defective product will have occurred for some time such that the losses will be high.

Other metrology techniques besides IPMS may also be problematic in the presence of a harshly acidic matrix. Thus, to address the need in the art for analysis of trace cation concentrations in acidic matrices, a “harsh chemistry module” such as disclosed in U.S. application Ser. No. 11/178,857 (the '857 application), the contents of which are incorporated by reference herein, eliminates harshly acidic matrices that would otherwise require dilution or analogous conventional acts to remove the acidic matrices. Unlike these conventional acts, the harsh chemistry module preserves the ability to characterize analytes such as trace metals and cations despite the elimination of the harshly acidic matrix. As disclosed in the '857 application, a column packed with weak anion exchange resin may be activated with a weakly acidic metal complexing reagent. For example, a weak anion exchange resin such as one implemented using tertiary amines may be activated with acetic acid. In general, a “weakly” acidic metal complexing reagent refers to a reagent having a pKa whose relationship to the pKa for the functional groups in the weak anion exchange resin is such that a substantial portion of the functional groups are left un-protonated after exposure to the weakly acidic metal complexing reagent.

With respect to the analysis or detection of metals in acidic matrices, suitable organic and inorganic weakly acidic metal complexing reagents to activate the resin include formic acid, acetic acid, oxalic acid, glycolic acid, ethylenediaminetetraacetic acid (EDTA), nitrotriacetic acid (NTA), diethylenetriaminepentaacetic acid (DTPA), ethylenediamine (EDA), glycine, and iminodiacetic acid (IDA). For example, acetic acid may be used to activate a column packed with the weak anion exchange resin. Because of the weak acidity of the metal complexing reagent, it is believed that only a relatively small percentage of the functional groups in the resin will be protonated. These positively-charged functional groups (such as positively-charged tertiary amines) may then adsorb or bind with the metal complexing anion formed after donation of the proton by the weakly acidic metal complexing reagent.

Note that one could reduce undesirable proton levels in harshly acidic matrices by simply eluting the acidic solutions through a column packed with a weak anion exchange resin. But there are problems such as metal retention and trapping, precipitation, and oxidation, which cause undesirable memory effects and other errors in the detection and quantification of the trace metal concentrations. If an anion exchange resin were simply used to eliminate an acidic matrix without any other processing, these trace metal analysis problems would remain. However, trace metal analysis is enabled by the initial activation of the resin by the weakly acidic metal complexing reagent. It is believed that this treatment leaves a relatively small percentage of the functional groups in the resin already protonated and associated with the resulting metal complexing anion. For example, with respect to the treatment of samples of SC2 solution, it is believed that this metal complexing anion will have a weaker binding affinity to the protonated functional group than will the chloride anion in the SC2 solution. Thus, the chloride anion exchanges with the metal complexing anion. The majority of the metal complexing anions will thus combine with the remaining protons in the SC2 solution to form the non-ionized metal complexing reagent because the bulk of a weak acid in solution does not disassociate into protons and anions. Those metal complexing reagent anions that are disassociated are then free to complex with and stabilize the trace metals. Advantageously, the complexing of the metal complexing anion such as acetate with metals is a soft bond such that it is easily disassociated even in a relatively gentle ionization process such as electrospray ionization. Moreover, because the metal complexing reagent is weakly acidic, the eluent from the weak anion exchange column has a pH that is kept substantially neutral, for example a pH of 6.7.

It is further believed that the weakly acidic metal complexing reagent provides an additional benefit besides complexing the metals in the treated solution. For example, a weak anion exchange resin will typically have a certain concentration of hydroxide ions distributed through the resin. In that regard, although a tertiary amine is only weakly basic, it is basic nonetheless and thus will have a tendency to ionize with a water molecule such that the tertiary amine becomes protonated and a hydroxide anion is produced. However, activation of the weak anion exchange resin with the weakly acidic metal complexing reagent eliminates these hydroxide ions from the resin prior to treating the acidic matrix. In contrast, consider what could happen should the resin not be activated by the weakly acidic metal complexing reagent. As the acidic matrix flows into a column of such un-activated resin, any hydroxide ions near the entry port of the column will be eliminated by the acid matrix. However, the matrix continues to be neutralized as it flows through the column such that the solution near the exit port of the column will have little acidity. Thus, hydroxide ions could still be present near the exit port within the resin. These hydroxide ions would thus be available to react with metals, thereby causing precipitates and hampering the ability to detect and/or characterize trace metals.

Having treated the harshly acidic solution, the weak anion exchange resin is easily regenerated with an appropriate strong base such as ammonium hydroxide, sodium hydroxide, or methylamine. In the regeneration of a weak anion exchange resin, the protonated basic sites are returned to their neutral basic states. For example, a protonated tertiary amine would be reduced to a neutral state upon regeneration. The regenerated column may then be re-activated by treatment with the weakly acidic metal complexing reagent to be ready to neutralize another sample of acidic matrix while stabilizing the trace metals.

As known in the art, the polymer backbone of a weak anion exchange resin may be based on synthetic polymers such as styrene-divinylbenzene copolymer, acrylic, polysaccharides, or many other suitable polymers. A weak anion exchange resin is generally supplied in the form of beads, which may either be dense (gel resins) or porous (macroporous resins). The technique disclosed in the '857 application is relatively insensitive to the particular form of the beads.

Despite the advance in the art represented by the '857 application, the required steps of activating the resin with a weakly acidic metal complexing reagent, treating the harshly acidic matrix, and then regenerating the resin using an appropriate base are time consuming. The time required to complete this acts hinders the throughput (the number of samples that may be analyzed in a given time period) in automated systems such as an IPMS system.

Accordingly, there is a need in the art for harsh chemistry modules that offer improved automation and throughput speed.

### SUMMARY

This section summarizes some features of the invention. Other features are described in the subsequent sections.

In accordance with an aspect of the invention, a matrix elimination apparatus is provided that includes: at least one column packed with a weak anion exchange resin; a sample source; a basic solution source; a weakly acidic metal complexing reagent source, and an at least one pump, wherein the matrix elimination apparatus is configured such that the at least one pump can sequence through the acts of: a) pumping the basic solution through the column to regenerate the column, b) pumping the weakly acid metal complexing reagent through the column to activate the column; and c) pumping the sample through the activated column to eliminate an acidic matrix in the sample.

In accordance with another aspect of the invention, a method is provided that includes the acts of: providing a plurality of columns packed with weak anion exchange resin; and for each of the columns, sequencing through the acts of: (a) regenerating the column with a basic solution; (b) activating the column with a weakly acidic metal complexing reagent; and (c) eliminating an acidic matrix within a sample by passing the sample through the activated column.

In accordance with another aspect of the invention, a system is provided that includes: a plurality of harsh chemistry modules, each module including at least one column packed with a weak anion exchange resin, each module being operable to sequentially activate its at least one column with a weakly acidic metal complexing reagent, process a sample having a harshly acidic matrix through the activated at least one column to provide a process sample, and regenerate its at least one column with a basic solution; and a metrology instrument operable to receive processed samples from the harsh; and chemistry modules to measure the concentration of at least one analyte in the processed samples.

The invention is not limited to the features and advantages described above. Other features are described below. The invention is defined by the appended claims.

### BRIEF DESCRIPTION OF THE DRAWINGS

FIG. 1 illustrates a harsh chemistry module in accordance with an embodiment of the invention.

FIG. 2 is a chart summarizing a pipelining process with respect to the ion-exchange columns in the module of FIG. 1 in accordance with an embodiment of the invention.

FIG. 3 is a block diagram of a multiple channel system incorporating harsh chemistry modules in accordance with an embodiment of the invention.

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

To provide greater processing speed and flexibility, a “harsh chemistry” module is provided with a plurality of ion-exchange columns. A pipelined analysis may thus be performed such that while one sample is being processed through a first one of the columns, other columns in the plurality may be activated or regenerated as necessary. In this fashion, after the first column has processed its sample, another sample may be processed through another column that was regenerated while the first column was processing its sample. The following exemplary embodiment uses two ion-exchange columns but it will be appreciated that a plurality of greater than two columns could also be implemented using the principles disclosed herein. Alternatively, embodiments may be implemented using a single column.

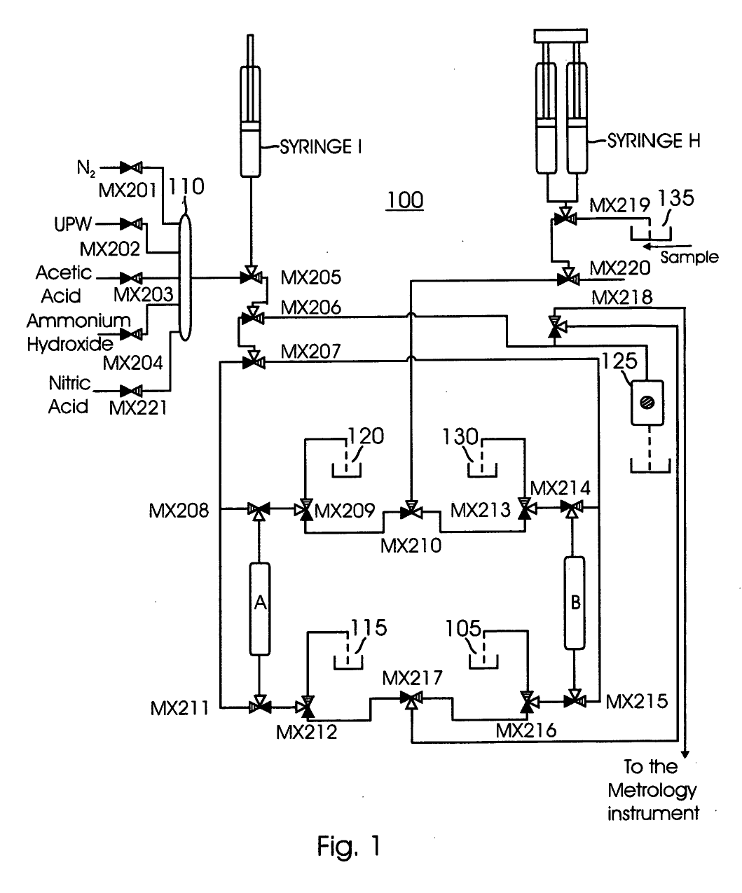

Turning now to FIG. 1, a harsh chemistry module 100 is implemented using a first ion-exchange column A and a second ion-exchange column B. Each column is constructed from a suitable material such as PEEK or PFE tubing packed with a weak anion exchange resin. In general, an ion exchange resin is an organic polymer to which active groups have been covalently attached. Depending on the properties of these groups, an ion exchange resin may be classified as either a cation or anion exchange resin. In an anion exchange resin, the functional or active groups that have been covalently bonded to the resin backbone are positively charged so that they may exchange negatively charged counter ions (anions). An anion exchange resin may be classified as either a weak or strong anion exchange resin depending upon the basicity of the active groups. As suggested by the name, the active groups in a weak anion exchange resin are weakly (rather than strongly) basic. Generally, a weak anion exchange resin uses tertiary amines or polyamines as the functional groups but it will be appreciated that numerous other functional or active groups having a sufficiently weak basicity (and suitability for covalent bonding to the resin) may also be used. The polymer backbone of the weak anion exchange resin may comprise a synthetic polymer such as styrene-divinylbenzene copolymer, acrylic, polysaccharides, or another suitable polymer.

Module 100 may be implemented in any automated analysis system that requires the elimination of harshly acidic matrices while retaining trace cation concentrations such as trace metals. As discussed above, one such system is an IPMS system as disclosed in U.S Pat. No. ______, entitled “In-Process Mass Spectrometry With Sample Multiplexing,” (the “sample multiplexing application”) Attorney Docket No. M-15608-1C US, filed Dec. 9, 2005, the contents of which are incorporated by reference herein. However, module 100 may be implemented in other types of automated metrology systems such as liquid chromatography systems. A controller (not illustrated) such as that discussed in the sample multiplexing application controls the operation of module 100.

As discussed in the sample multiplexing application, an extracted sample may be mixed with an appropriate spike so that an IPMS system may measure the concentration of an analyte in the extracted sample using a ratio measurement. For example, the spike may alter a naturally-occurring isotopic ratio for the analyte such that the ratio measurement becomes that practiced in isotope dilution mass spectrometry (IDMS). Alternatively, the spike may not alter the isotopic ratio but rather be sufficiently close in chemical behavior and molecular weight that the spike's response in the mass spectrometer may be used to calibrate the response of the analyte as practiced in an internal standard method. In either case, the ratio measurement naturally cancels drift and other inaccuracies so that the analyte(s) in the sample may be accurately characterized.

The resulting mixture of sample and spike solution is received at a syringe pump H through a three-way valve MX219 (to simplify the remaining discussion, the mixture of sample and spike will simply be denoted as “sample”). For illustration purposes, the common port of a three-way valve such as MX219 is left blank. The port normally connected to the common port is checkered. Finally, the port that is connected to the common port when the three-way valve is actuated is darkened. To eliminate the acidic matrix in the sample withdrawn into syringe pump H, three-way valves MX 219 and a three-way valve MX220 are actuated while syringe pump H depresses its plunger to pump out the sample towards a three-way valve MX210. Depending upon the actuation of valve MX210, the sample is then pumped into either column A or column B.

The controller determines which column receives the sample depending upon which column has just been regenerated and activated. For example, suppose column B has been regenerated and activated. In such a case, valve MX210 needs no actuation to direct the sample towards column B through a three-way valve MX213 into a drain 130 so that an initial volume (for example, 0.5 ml) of sample may be discarded to flush the line prior to analysis. Valve MX213 and a three-way valve MX214 may then be actuated to allow sample to flow into column B. Upon passing through column B, an initial volume (for example, 0.5 ml) of the processed sample passes as eluent from column B and may flush through actuation of a three-way valve MX215 and through a three-way valve MX216 into a drain 105. After flushing this initial volume, valve MX 216 may be actuated so that the processed sample flows through a three-way valve MX 217 towards a mass spectrometer (not illustrated) or some other type of metrology instrument. A processed sample thus has its acidic matrix eliminated as discussed in the '857 application. As used herein, a matrix is considered “eliminated” when the pH is sufficiently high to permit analysis by the desired metrology instrument (which analysis would otherwise be obviated by the pre-existing harshly acidic matrix in the sample). In that regard, a processed sample having an “eliminated” matrix need not have a pH of 7.0, for example, a pH of 4.0 may be sufficient to allow subsequent analysis by the downstream metrology instrument.

While column B was processing sample in this fashion, column A may be regenerated and activated. To regenerate column A (assuming that it has just processed sample), an ammonium hydroxide solution having a suitable molarity such as 2.0M is then pumped through a manifold 110 upon actuation of a valve MX204 to a three-way valve MX205. Valve MX205 and a syringe I are then actuated so that the ammonium hydroxide solution is withdrawn into the body of syringe I. The plunger of syringe I may then be depressed to pump the ammonium hydroxide through valves MX205 and through actuated three-way valves MX206 and MX207 so that the ammonium hydroxide solution flows towards column A. To better regenerate column A, ammonium hydroxide may flow in both directions through the column. Thus, a three-way valve MX211 may be actuated so that ammonium hydroxide flows through a three-way valve MX208 into column A. From column A, the ammonium hydroxide solution may flow through valve MX211 and through a three-way valve MX212 into a drain 115. To reverse the flow direction in column A, valve MX206 is actuated so that ammonium hydroxide solution flows through valve MX211, column A, valve MX208 to a three-way valve MX209. From valve MX209, the ammonium hydroxide solution flows into a drain 120. It will be appreciated that the order of the forward flow direction/reverse flow direction steps for column A is arbitrary such that the reverse flow step may be performed first. In that regard, practicing the reverse flow step first if advantageous because the absorbed matrix will be more concentrated at the entry of the columns (nearest valves MX208 and MX214, respectively). Moreover, although regenerating the column using both flow directions ensures the best regeneration possible, embodiments of module 100 may also be practiced using a single flow direction.

After column A has been regenerated, it may be cleansed with a solvent such as ultra-pure water (UPW). Thus, a valve MX202 at manifold 110 may be actuated to allow UPW to flow towards column A. The forwards and backwards cleansing with UPW of column A may then proceed as discussed above with regard to regeneration of the column using ammonium hydroxide. Having cleansed the column with a solvent such as UPW, the column may be activated with a weakly acidic metal-complexing reagent such as dilute acetic acid (0.5M). To begin the activation, a valve MX203 is activated at manifold 110 so that acetic acid may flow towards column A. The forwards and backwards activation of column A may then proceed as discussed above with regard to regeneration. The activation of column A may be followed with another cycle (both forwards and backward) of UPW cleansing. At this point, column A is ready to process a sample. However, because excess solution within column A would dilute the processed sample thereby leading to potentially inaccurate estimations of analyte concentrations, the column may be flushed with a suitable inert gas such as compressed N₂. To allow N₂ to flow through column A, a valve MX201 at manifold 110 is actuated. A forwards and backwards flushing of column A using N₂ may then proceed as discussed with regard to regeneration, with the exception that syringe pump I need not be used. Having been regenerated, cleansed with solvent, activated, cleansed with solvent, and finally flushed with gas, column A is then ready to receive a sample as pumped by syringe H.

To eliminate contamination of the various components in module 100, a suitably strong acid such as nitric acid may flush through module 100 upon actuation of a valve MX221 at manifold 110. However, assuming no contamination is suspected, normal operation needs no acid flushing.

To verify the operation of the columns, processed sample may flow through an actuated three-way valve MX218 into a pH meter 170. For example, in some embodiments, it is expected that processed sample will have a pH between 4 and 5. Should, however, testing by pH meter 125 indicate that processed sample has a pH of 2, a malfunctioning column may be indicated. The pH meter may also be used to test the molarity of the acetic acid. Because the acetic acid used to activate the columns may be formed through dilution of more concentrated acetic acid, the concentrated acetic acid may be used to calibrate the pH meter. In addition, to test the pH of the diluted acetic acid so as to verify its molarity, a volume of the diluted acetic acid solution may occasionally be delivered from syringe I through valves MX205, MX206, and MX218 to the pH meter.

Column B is regenerated and activated analogously to column A. To begin the regeneration of column B, ammonium hydroxide solution is withdrawn into the body of syringe I as discussed above and pumped through valves MX205, actuated valve MX206, valve MX207, and valve MX214 into column B to regenerate column in the forward flow direction through actuated valve MX215 and valve MX216 into drain 105. Similarly, column B is regenerated in the reverse flow direction by actuating valve MX214 so that ammonium hydroxide solution flows from column B, through valves MX214 and MX213 into drain 130. Column B is then cleansed with UPW, activated with acetic acid, and cleansed with UPW again in the same manner. Finally, excess solution is flushed from column B using, for example, the compressed N₂. Syringe pump H may be rinsed between samples by withdrawing UPW from manifold 110 into the syringe pump body. The UPW rinse may then be dumped into a drain such as drain 130.

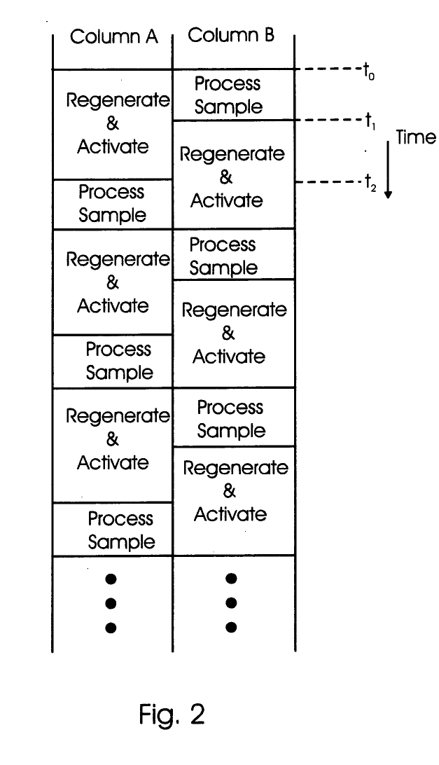

To increase the sample processing rate, columns A and B should be operated in a pipelined fashion. Because the column regeneration and activation involves more steps than just processing sample to eliminate the acidic matrix, the regeneration and activation process may take approximately twice as long as the sample processing. Given this exemplary relationship, the staggered pipelined process as outlined in FIG. 2 is most efficient. At time to, column A begins a regeneration and activation cycle as discussed above. During the first half of this cycle, column B may process a sample, finishing at time t₁. Column B may then begin a regeneration and activation cycle. At time t₂, column A has finished its regeneration and activation cycle and may begin to process a sample, and so on. By staggering the regeneration and activation cycles in this manner, it may be ensured that columns A and B do not overlap in processing their sample. In this fashion, the samples may be processed in real time without requiring storage of a processed sample while another processed sample is being analyzed in the downstream metrology instrument.

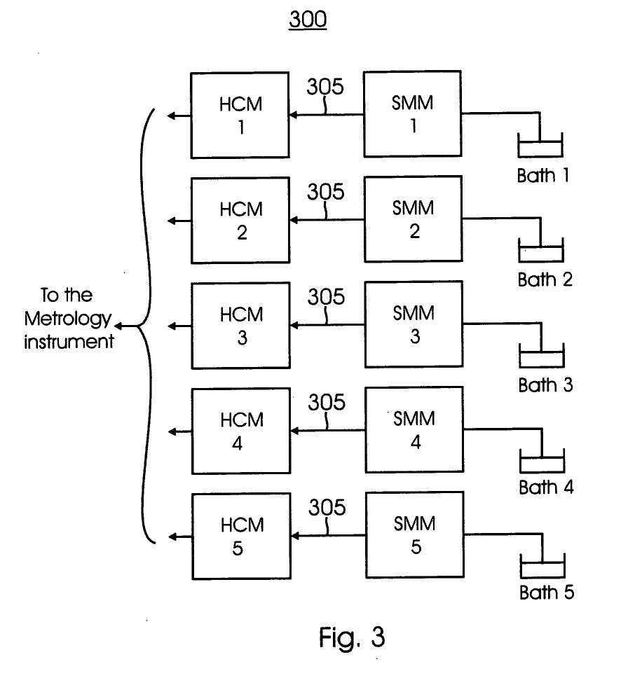

It will be appreciated that should module 100 be modified to include greater than two ion-exchange columns, the sample processing rate to eliminate the acidic matrices is increased proportionately. Moreover, the use of multiple channels as discussed, for example, in the sample multiplexing application provides for a further increase in processing rate. Turning now to FIG. 3, a multiple channel system 300 is illustrated. Each channel 305 includes a sample mix module (SMM) such as described in the sample multiplexing application that is adapted to draw a sample from a corresponding bath, spike the sample, and deliver it to a corresponding harsh chemistry module (HCM). A first channel 305 has its modules designated as HCM 1 and SMM 1 processing a sample extracted from a bath 1, a second channel 305 has its modules designated as HCM 2 and SMM 2, and so on for a total of five channels. It will be appreciated, however, that the number of channels is arbitrary. Moreover, although system 300 is illustrated as sampling baths 1 through 5, other embodiments of system 300 could be used to sample other types of process solutions. The sample extraction modules that withdraw samples from the baths and provide the samples to the SMMs are not shown for illustration clarity. In that regard, although each SMM is shown receiving samples from a single bath, each SMM may receive samples from multiple baths by using the multiplexed sample extraction scheme described, for example, in the sample multiplexing application. Advantageously, system 300 allows a user to analyze trace cation concentrations such as trace metals using metrology systems that would otherwise be unsuitable due to the harshly acidic matrix in the samples being analyzed. Moreover, this analysis can be performed real time in contrast to the cumbersome and offline practices in the prior art as discussed above.

The above-described embodiments of the present invention are merely meant to be illustrative and not limiting. Various changes and modifications may be made without departing from this invention in its broader aspects. For example, embodiments may be implemented using just a single column. Therefore, the appended claims encompass all such changes and modifications as falling within the true spirit and scope of this invention.

We claim:

1. A matrix elimination apparatus for eliminating an acidic matrix, comprising:
at least one column packed with a weak anion exchange resin;
a source of samples, each sample having an acidic matrix;
a basic solution source;
a weakly acidic metal complexing reagent source, and
an at least one pump, wherein the matrix elimination apparatus is configured such that the at least one pump can sequence through the acts of: a) pumping the basic solution through the column to regenerate the column, b) pumping the weakly acid metal complexing reagent through the column to activate the column; and c) pumping one of the samples through the activated column to provide a processed sample whose acidic matrix is eliminated.

2. The matrix elimination source of claim 1, wherein the at least one pump comprises a first pump and a second pump and the at least one column comprises at least two columns, and wherein the matrix elimination apparatus is further configured such that while the first one of the pumps sequences through acts (a) and (b) with regard to a first one of the columns, the second one of the pumps performs act (c) with regard to a remaining one of the columns.

3. The matrix elimination source of claim 2, wherein the first and second pumps are syringe pumps.

4. The matrix elimination apparatus of claim 1, further comprising at least one drain, wherein the matrix elimination apparatus is configured such that act (a) comprises sequentially pumping the basic solution in a first direction through the column into the at least one drain and pumping the basic solution in an opposite direction through the column into the at least one drain.

5. The matrix elimination apparatus of claim 1, further comprising at least one drain, wherein the matrix elimination apparatus is configured such that act (b) comprises sequentially pumping the weakly acidic metal complexing reagent in a first direction through the column into the at least one drain and pumping the weakly acidic metal complexing reagent in an opposite direction through the column into the at least one drain.

6. The matrix elimination apparatus of claim 1, further comprising a controller operable to control the sequencing of acts (a) through (c).

7. The matrix elimination apparatus of claim 2, further comprising a solvent source, and wherein the matrix elimination apparatus is further configured such that, for each of the columns, the first pump pumps solvent from the solvent source through the column after each of acts (a) and (b).

8. The matrix elimination apparatus of claim 7, wherein the solvent source is a UPW source, the basic solution source is an ammonium hydroxide solution source, and the weakly acidic metal complexing reagent source is an acetic acid source.

9. The matrix elimination apparatus of claim 1, further comprising a compressed gas source, and wherein the matrix elimination apparatus is further configured to purge the at least one column after act (b).

10. The matrix elimination apparatus of claim 1, wherein the weak anion exchange resin is a tertiary amine resin.

11. The matrix elimination apparatus of claim 1, further comprising a metrology instrument operable to analyze a concentration of an analyte in the processed samples.

12. The matrix elimination apparatus of claim 11, wherein the metrology instrument comprises a high performance liquid chromatography system.

13. The matrix elimination apparatus of claim 11, wherein the metrology instrument comprises a mass spectrometer.

14. The matrix elimination apparatus of claim 13, wherein the mass spectrometer is an inductively-coupled-plasma mass spectrometer.

15. The matrix elimination apparatus of claim 13, wherein the mass spectrometer is an electrospray mass spectrometer.

16. A method, comprising:
providing a plurality of columns packed with weak anion exchange resin; and
for each of the columns, sequencing through the acts of:
(a) regenerating the column with a basic solution;
(b) activating the column with a weakly acidic metal complexing reagent; and
(c) eliminating an acidic matrix within a sample by passing the sample through the activated column.

17. The method of claim 16, wherein while one of the columns sequences through acts (a) and (b), another one of the columns sequences through act (c).

18. The method of claim 16, wherein act (a) comprises sequentially flowing the basic solution in a first direction through the column and then in an opposite direction through the column.

19. The method of claim 16, wherein act (b) comprises sequentially flowing the weakly acidic metal complexing reagent in a first direction through the column and then in an opposite direction through the column.

20. A system, comprising:
a plurality of harsh chemistry modules, each module including at least one column packed with a weak anion exchange resin, each module being operable to sequentially activate its at least one column with a weakly acidic metal complexing reagent, process a sample having a harshly acidic matrix through the activated at least one column to provide a process sample, and regenerate its at least one column with a basic solution;
a metrology instrument operable to receive processed samples from the harsh; and chemistry modules to measure the concentration of at least one analyte in the processed samples.

21. The system of claim 20, wherein the metrology instrument is an electrospray mass spectrometer.
